(19) United States
(12) Patent Application Publication
(10) Pub. No.: US 2022/0410248 A1
(43) Pub. Date: Dec. 29, 2022

(54) POWERTRAIN DRUM AND METHOD OF PRODUCING THE SAME

(71) Applicant: METAL FORMING & COINING CORPORATION, Maumee, OH (US)

(72) Inventors: Timothy John Cripsey, Rochester, MI (US); Erik E. Piper, Harrison Township, MI (US)

(21) Appl. No.: 17/808,587

(22) Filed: Jun. 24, 2022

Related U.S. Application Data
(60) Provisional application No. 63/214,859, filed on Jun. 25, 2021.

(51) Int. Cl. B21D 53/28; F16H 55/17

(52) U.S. Cl. CPC B21D 53/28; F16H 55/17; F16H 2055/176

(57) ABSTRACT

A method of producing a drum including providing at least one source of at least one material, producing a preform from the at least one material, bending edges of the preform into a rolled preform and joining the edges to form a tubular member, performing an expansion operation and/or a contraction operation on the tubular member to achieve at least one desired diameter of the drum, heat-treating of the tubular member, forming a plurality of engagement elements in the tubular member, machining the tubular member, heat-treating the drum to achieve a desired hardness, assembling at least one secondary component with the tubular member, and balancing the drum.

### CROSS-REFERENCE TO RELATED APPLICATION

This application claims the benefit of U.S. Provisional Patent Application Ser. No. 63/214,859, filed Jun. 25, 2021, the entirety of which is herein incorporated by reference.

### FIELD

The disclosure relates to a drum for use in a torque transmitting assembly configured to transmit torque between a driving member and a driven member, and more particularly to a drum configured to engage the driving member or the driven member and a method of producing the drum.

### BACKGROUND

This section provides background information related to the present disclosure which is not necessarily prior art.

In an automatic transmission system, torque is transmitted from component to component within the transmission by a torque transmitting component or assembly. In addition to transmitting torque, these components/assemblies at times, have to perform secondary functions, such as allowing oil flow, allowing sensors to be read through the walls of the components etc.

While steel is the most common material of choice, there are times where it is necessary to use aluminum. This is normally driven by a strong technical need such as weight savings or the allowance of a sensor to be read through a component wall. The limited application of aluminum in powertrain components is because of cost, strength and wear concerns tied to aluminum.

Aluminum typically is not an appropriate material for such components as annulus gears, but it can be used for a drive shell or a drum of the torque transmitting assembly, which transmit the torque between annulus gears and other supporting or torque-controlling structures within the transmission. Conventional drums are often formed from a flow forming process. An example of such an assembly and method of forming of the drums is shown and described in U.S. Pat. Nos. 7,021,171; 7,328,492; and 10,517,071, the entire disclosures of which are hereby incorporated herein by reference. The known drum is shown in FIGS. 1-4 and a process for producing the drum is shown in FIG. 5.

The current process for producing the drum is expensive and requires expensive machining due to the forming process use. Extensive capital is also required for the part production equipment/line. Inherent process variability leads to significant number of balancing holes required and weight saving holes have to be added after the tube has been formed, requiring cam-based tooling that is expensive to manufacture. Moreover, the drum requires a secondary component (steel sensor ring) to be assembled after the drum is completed.

Accordingly, it would be desirable to produce a drum for use in a torque transmitting assembly wherein a weight, a cost, and complexity thereof is minimized, while a process for producing the drum is optimized.

### SUMMARY

In concordance and agreement with the presently described subject matter, a drum and a process for producing the drum, which minimizes a weight, a cost, and complexity of the drum, while optimizing a process for producing the drum, have surprisingly been discovered.

In one embodiment, a method of producing a drum, comprises: providing at least one source of at least one material; producing a preform from the at least one material having at least one feature of the drum formed therein; forming the preform into a tubular member; and assembling at least one secondary component with the tubular member to produce the drum.

In some embodiments, the forming of the preform into the tubular member includes bending edges of the preform into a rolled tube shape and joining the edges to form the tubular member.

In some embodiments, the method further comprises performing at least one of an expansion operation and a contraction operation to form at least one region in the tubular member having at least one desired diameter of the drum.

In some embodiments, the performing of the at least one of the expansion operation and the contraction operation forms in the tubular member a first parallel region, a second parallel region, a third parallel region, a first conical region formed between the first and second parallel regions, and a second conical region formed between the second and third parallel regions.

In some embodiments, the performing of the at least one of the expansion operation and the contraction operation forms in the tubular member a plurality of parallel regions, and wherein each of the parallel regions is separated from another one of the parallel regions by a perpendicular step.

In some embodiments, the method further comprises heat-treating the tubular member for formability of the tubular member.

In some embodiments, the heat-treating of the tubular member for formability is after performing at least one of an expansion operation and a contraction operation on the tubular member.

In some embodiments, the method further comprises forming at least one engagement element in the tubular member.

In some embodiments, the method further comprises machining the tubular member.

In some embodiments, the method further comprises heat-treating the tubular member to achieve a desired hardness.

In some embodiments, the method further comprises balancing the drum.

In some embodiments, the at least one feature of the drum includes at least one aperture.

In some embodiments, the at least one feature of the drum includes at least one engagement element configured to cooperate and engage with at least one of the at least one secondary component and at least one component of a powertrain of a vehicle.

In some embodiments, the at least one feature of the drum includes at least one receiving element configured to cooperate with the at least one secondary component.

In some embodiments, the at least one feature of the drum includes an element suitable for sensor readability.

In some embodiments, at least a portion of the element suitable for sensor readability is produced from an aluminum material.

In some embodiments, the at least one secondary component is a gear of a powertrain of a vehicle.

In some embodiments, the forming of the preform produces one of a substantially right cylindrical tubular member and a substantially conical tubular member.

In another embodiment, a method of producing a drum, comprises: providing at least one source of at least one material; producing a preform from the at least one material, the preform having at least one feature of the drum formed therein, wherein the at least one feature of the drum includes an array of receiving elements formed therein; forming the preform into a rolled preform; disposing a gear into the rolled preform, the gear having a plurality of protuberances formed on an outer circumferential surface thereof, wherein each of the protuberances of the gear is received in a corresponding one of the receiving elements formed in the rolled preform; and joining edges of the rolled preform to form a tubular member and secure the gear therein.

In yet another embodiment, a powertrain drum for a vehicle, comprises: a tubular member produced from a preform having at least one feature of the powertrain drum provided therein, wherein the tubular member includes at least one of a plurality of engagement elements and a plurality of receiving elements formed therein; and at least one secondary component disposed in the tubular member, wherein the at least one secondary component cooperates with at least one of the engagement elements and the receiving elements of the tubular member to maintain a position thereof within the tubular member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side perspective view of a drum according to prior art;

FIG. 2 is a side elevational view of a drum according to prior art;

FIG. 3 is a top perspective view of a drum according to prior art;

FIG. 4 is an end perspective view of a drum according to prior art;

FIG. 5 is a flow diagram showing a process for producing a drum according to prior art;

FIG. 6 is a flow diagram showing a method for producing a drum according to an embodiment of the presently disclosed subject matter;

FIG. 7 is a top plan view of a preform used in the method of FIG. 6;

FIG. 8 is a side perspective view of a tubular member formed from the preform shown in FIG. 7;

FIG. 9 is an end perspective view of the tubular member formed from the preform shown in FIG. 7;

FIG. 10 is a cross-sectional view of the tubular member of FIG. 8 taken along an A-axis, after undergoing a combination of expansion and contraction operations according to an embodiment of the presently disclosed subject matter;

FIG. 11 is a cross-sectional view of the tubular member of FIG. 8 taken along an A-axis, after undergoing a combination of expansion and contraction operations according to another embodiment of the presently disclosed subject matter;

FIG. 12 is a side perspective view of a drum formed from the tubular member of FIGS. 7 and 8, after steps to form engagement elements on the tubular member and form the drum and without undergoing the combination of expansion and contraction operation shown in FIGS. 10 and 11;

FIG. 13 is a cross-sectional view of a tubular member according to another embodiment of the presently disclosed subject matter, showing a region of the tubular member produced from a material suitable for sensor reading ability, wherein the material is not necessary in other regions of the drum;

FIG. 14 shows a preform for forming the tubular member of FIG. 13;

FIG. 15 is a flow diagram showing a method for producing a drum according to another embodiment of the presently disclosed subject matter;

FIG. 16 is an end perspective view of the drum produced by the method of FIG. 15;

FIG. 17 is a perspective view of a preform used to produce the drum of FIG. 16; and

FIG. 18 is an exploded perspective view of the drum of FIG. 16.

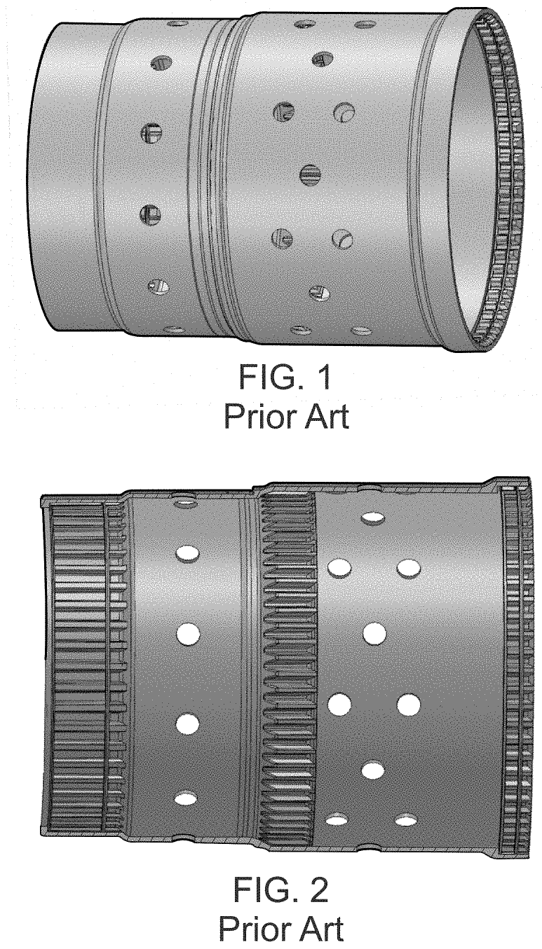

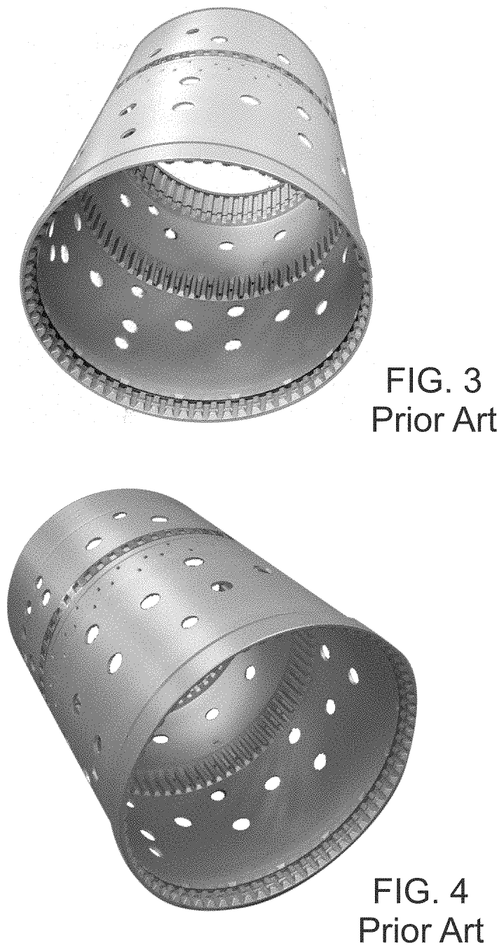

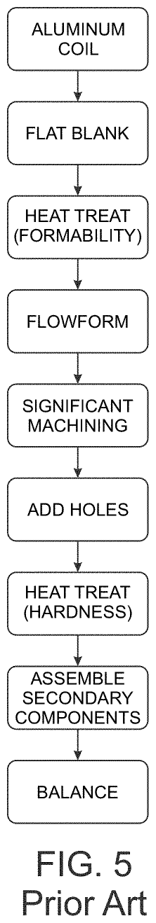

### DETAILED DESCRIPTION OF AN EMBODIMENT OF THE DISCLOSURE

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

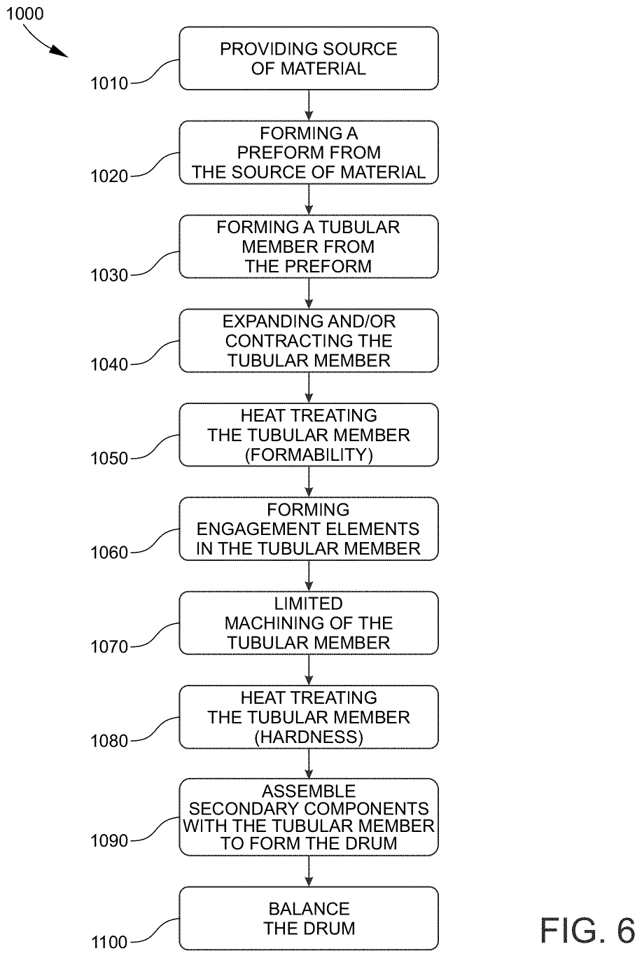

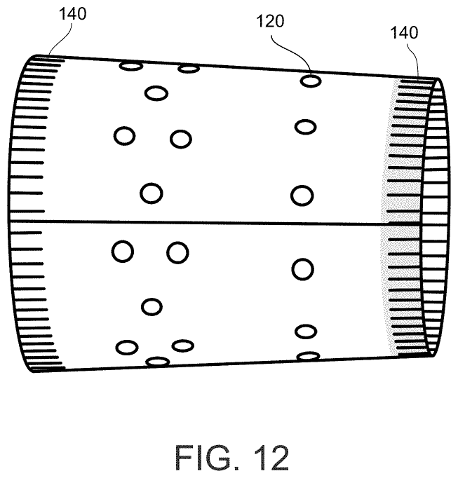

The present technology provides a drum 100, shown in FIG. 12, and a method 1000 of manufacturing the drum 100, shown in FIG. 6. The drum 100 may be employed in a powertrain (not depicted) of a vehicle, if desired. It is understood, however, that the drum 100 may be employed in other systems and applications, as desired, such as commercial, industrial, agricultural applications, for example.

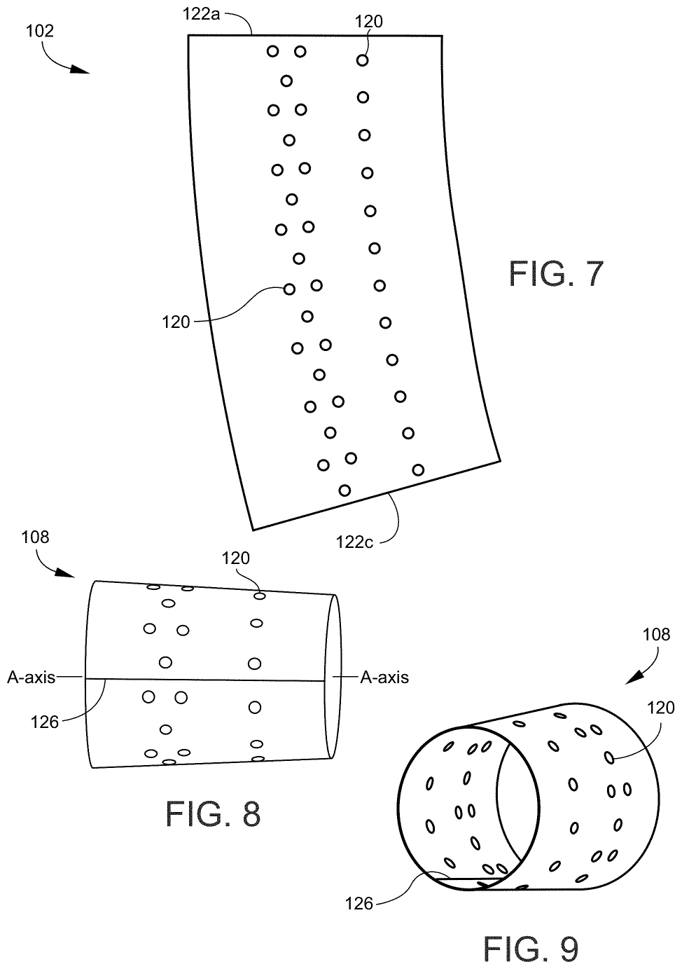

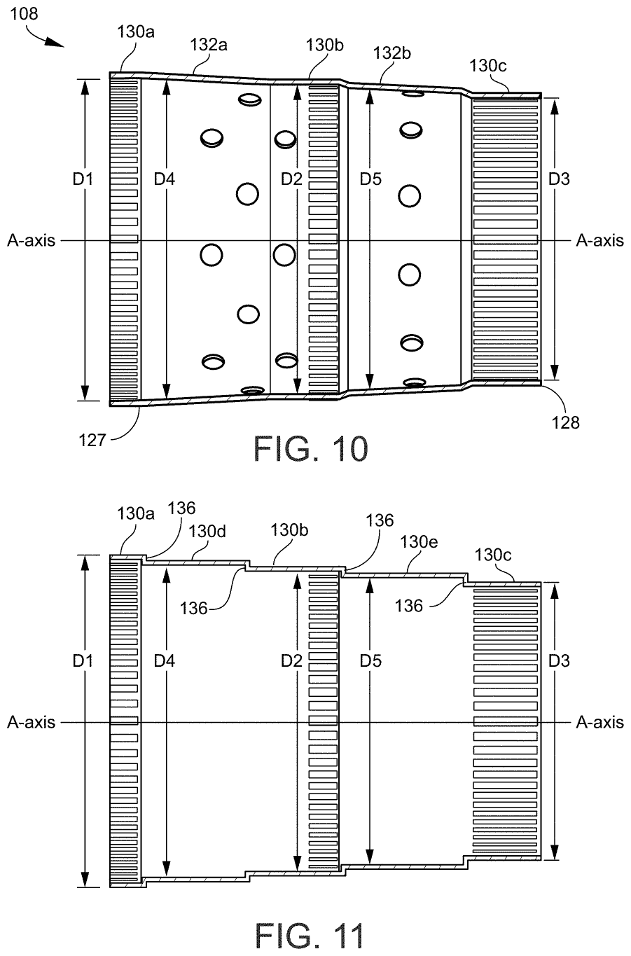

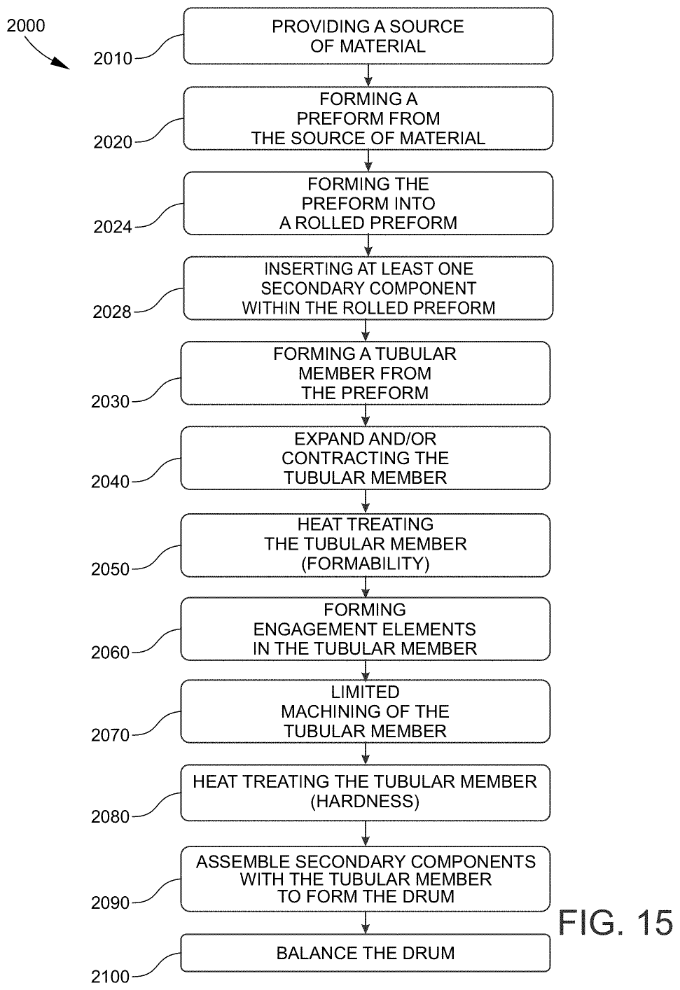

The method 1000 includes step 1010 providing at least one source of at least one material (not depicted). In step 1020, a preform 102 (see FIG. 7) is formed from the at least one source of the at least one material. Thereafter, in step 1030, the preform 102 is manipulated (e.g. rolled) and edges 122a, 122b thereof are joined to form a tubular member 108 (see FIGS. 8 and 9). The method 1000 may further comprise step 1040 in which an expansion operation and/or a contraction operation is performed on the tubular member 108 (see FIGS. 10 and 11). The tubular member 108 may then be subjected to a heat-treating process for formability in step 1050. A plurality of engagement elements 138 (e.g. splines, apertures) may then be formed on an inner surface of the tubular member 108 (see FIGS. 10 and 11) and/or a plurality of engagement elements 140 (e.g. splines, apertures) formed on an outer surface of the tubular member 108 (see FIG. 12) in step 1060, if desired. In step 1070, limited machining may also conducted on the tubular member 108. Heat-treating may again be performed at step 1080 to achieve a desired hardness of the tubular member 108. In step 1090, secondary components 112 such as a gear, for example, may be disposed and/or assembled with the tubular member 108 to produce the drum 100 (see FIG. 15). Thereafter, the drum 100 may be balanced in step 1100.

The inventive manufacturing method 1000 and design of the drum 100 are considerably different from the current process and design of conventional drums. However, the drum 100 is configured to be used into existing packaging constraints.

To produce the generally planar preform 102, it is separated from the at least one source of the at least one material. Such process may involve “unfolding” the material from the one or more sources. The preform 102 may be formed by stamping, cutting, snipping, a combination of various forming processes, and the like, for example. Preferably, the preform 102 includes as many features of the drum 100 as possible. The features of the drum 100 which may be provided in the preform 102 include, but are not limited to, a developed profile of the preform 102 that, when rolled, forms a desired shape (i.e. a substantially right cylindrical tube shape, a substantially conical tube shape, and the like); at least one aperture 120; the edges 122a, 122b formed in a condition for joining with each other; a generally interference-free element 150 suitable for sensor readability; and/or the engagement elements 138, 140 configured to cooperate and engage with one or more of the secondary components 112 and/or other components of the powertrain. It should be appreciated that the preform 102 may be provided with more or less features than shown to reduce or eliminate manufacturing and/or assembling processes needed to produce the drum 100.

As illustrated in FIGS. 7 and 14, the preform 102 may be formed with a plurality of the apertures 120. The apertures 120 may formed through the preform 102 in any suitable pattern, configuration, number, shape, and size as desired to reduce a weight of the drum 100, balance the drum 100, and/or permit a flow of a fluid (i.e. oil) therethrough.

In one embodiment, the preform 102 may be formed as a one-piece preform 102 as shown in FIG. 7. In other embodiments, however, the preform 102 may be a multi-piece preform 102 comprising a plurality of pieces joined together by any joining method. For example, the pieces of the preform 102 may be joined together by a welding operation. A thickness of the preform 102 may be substantially equal to a thickness of a finished wall thickness of the drum 100 which eliminates a need for machining stock. It is understood that the thickness of the preform 102 may be generally constant. However, the thickness of the preform 102 may be varied. In certain embodiments, at least two of the pieces of the multi-piece preform 102 may have different thickness, thereby resulting in a varied, finished wall thickness of the drum 100, if desired. By varying the wall thickness of the drum 100, a product weight and cost may be reduced. One material used to produce the preform 102 may be an aluminum material. However, it is understood that other materials having required properties may be used as desired such as a steel material, for example. It should be appreciated that the preform 102 may be formed completely from one material or numerous materials, if desired. For the multi-piece preform 102, at least two of the pieces may be formed from different materials.

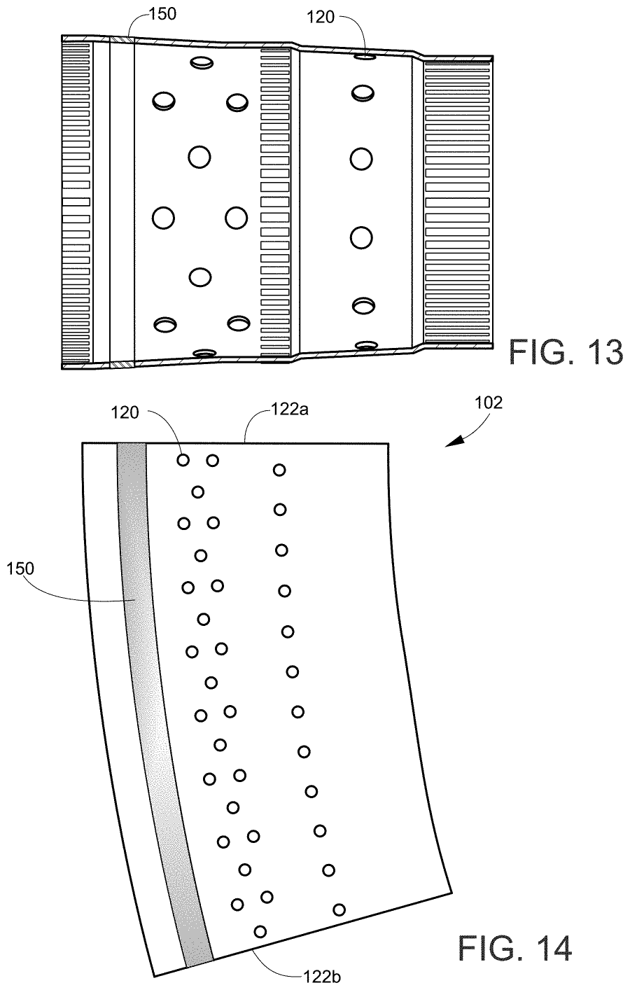

Referring now to FIG. 13, the tubular member 108 may further include the element 150 suitable for sensor readability. In other embodiments, the element 150 may be part of a sensor (not depicted). As illustrated, the element 150 may be integrated into the tubular member 108. More preferably, the element 150 may be integrally formed into the preform 102, as depicted in FIG. 14, prior to rolling and forming thereof. This would eliminate the assembly and stake operations and management of another component supplier currently required in conventional drums, while reducing capital equipment spend and improving product quality of the inventive drum 100. An aluminum material may be employed for the element 150 to allow the sensor to monitor parts inside of the drum 100. It is understood, however, that the material used for the element 150 may be any material suitable for sensor readability and/or to allow monitoring of the parts inside the drum 100 as desired. In the embodiments employing the multi-piece preform 102, at least a portion of one of the pieces joined together to form the preform 102 may form the element 150, reducing a cost of the drum 100 without changing a function thereof. As a non-limiting example, the at least a portion of the one of the pieces may be formed from the aluminum material. As another non-limiting example, one of the pieces of the preform 102 may be produced from a steel material having an aluminum strip for the element 150 integrated therein. As a further embodiment, a bi-metallic preform 102 may be employed. The bi-metallic preform 102 may be produced from a combination of steel and aluminum materials. It should be appreciated that the piece or the portion of the preform 102 produced from the aluminum material may be relatively small as depicted in FIG. 14.

Once the preform 102 is formed, the preform 102 may be manipulated to form a tubular member 108 as shown in FIGS. 8 and 9. The tubular member 108 is formed by causing the preform 102 to coil and joining the edges 122a, 122b of the preform 102. In the embodiment shown, the preform 102 is roll formed or press formed into either a standard tubular shape or a conically-shaped tube. Then the tube may then be seam welded to form the tubular member 108. However, it is understood that any rolling process or joining process can be used. In some embodiments, the edges 122a, 122b may be joined using laser welding to form a seam 126. Once joined, the seam 126 between the edges 122a, 122b of the preform 102 may be planished to improve a formability of the tubular member 108. Other metalworking techniques may also be used if desired.

Subsequent to the joining step and the planishing step, the tubular member 108 may undergo at least one of an expansion operation and a contraction operation to further form the tubular element 108 illustrated in FIGS. 10 and 11. The purpose of the expansion operation and/or the contraction operation may be to improve diametral tolerances of the rolled and welded tubular member 108 and/or setting spline diameters parallel to a central A-axis if the tubular member 108 has a generally conical shape. When the tubular member 108 has the generally conical shape, an inner diameter gradually decreases from a first end 127 to a second end 128 thereof.

In certain embodiments, the tubular member 108 may comprise at least one parallel region 130 and at least one conical region 132 relative to the central A-axis. As a non-limiting example, the tubular member 108 includes a first conical region 132a and a second conical region 132b interposed between a first parallel region 130a, a second parallel region 130b, and a third parallel region 130c. As best seen in FIG. 10, each of a first diameter D1 of the first parallel region 130a, a second diameter D2 of the second parallel region 130b, and a third diameter D3 of the third parallel region 130c, may be generally constant along a length thereof with the second diameter D2 being less than the first diameter D1 and the third diameter D3 being less than the second diameter D2. A fourth diameter D4 of the first conical region 132a may gradually decrease along a length thereof from the first parallel region 130a to the second parallel region 130b and a fifth diameter D5 of the second conical region 132b may gradually decrease along a length thereof from the second parallel region 130b to the third parallel region 130c. Formation of the parallel regions 130a, 130b, 130c and the conical regions 132a, 132b may be conducted in any order. For example, the parallel regions 130a, 130b, 130c may be formed prior to formation of the conical regions 132a, 132b. In other embodiments, the conical regions 132a, 132b may be formed prior to formation of the parallel regions 130a, 130b, 130c. In another embodiment, the parallel regions 130a, 130b, 130c and the conical regions 132a, 132b are formed in an alternating manner with one another. In yet other embodiments, the parallel regions 130a, 130b, 130c and the conical regions 132a, 132b are formed concurrently.

Referring now to the embodiment shown in FIG. 11, the tubular member 108 may comprise a plurality of parallel regions 130 relative to the central A-axis. As a non-limiting example, the tubular member 108 includes a first parallel region 130a, a second parallel region 130b, a third parallel region 130c, a fourth parallel region 130d, and a fifth parallel region 130e. Each of the parallel regions 130a, 130b, 130c, 130d, 130e may be separated from another one of the parallel regions 130a, 130b, 130c, 130d, 130e by a perpendicular step 136. Each diameter D1, D2, D3, D4, D5 of the respective parallel regions 130a, 130b, 130c, 130d, 130e is generally constant along a length thereof yet gradually decrease along a length of the tubular member 108 from one of the diameters D1, D2, D3, D4, D5 to an adjacent one of the diameters D1, D2, D3, D4, D5 to form a generally conical shape.

In yet another embodiment, the tubular member 108 may have a generally constant diameter along the length thereof to form a substantially right cylindrical shape. As such, the diameter D1, D2, D3, D4, D5 of each of the parallel regions 130a, 130b, 130c, 130d, 130e may be the same or substantially similar.

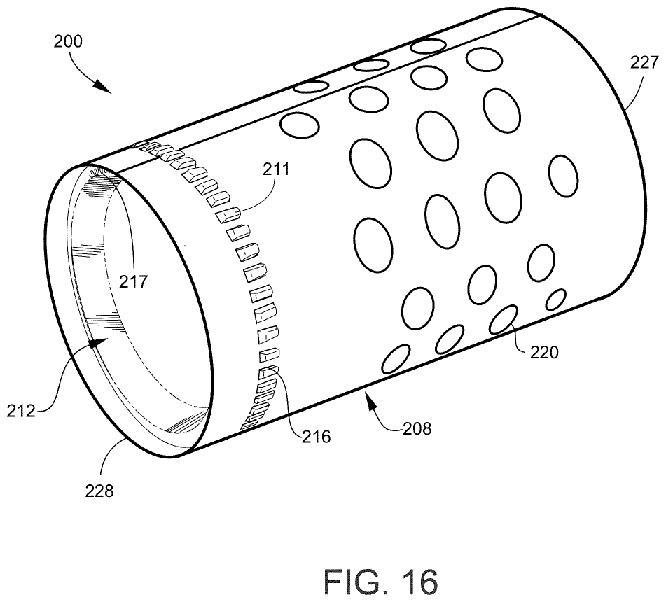

As more clearly shown in FIGS. 10 and 11, each of the parallel regions 130a, 130b, 130b may include the engagement elements 138 formed on an inner surface thereof. The engagement elements 138 may be formed on the tubular member 108 after the expansion operation and/or the contraction operation. Further, an outer surface of the tubular member 108 may include the engagement elements 140 formed thereon intermediate the first end 127 and the second end 128 thereof. In certain embodiments, the engagement elements 138 and/or the engagement elements 140 may be configured for cooperation and engagement with a plurality of engagement elements of one or more of the secondary components 112 and/or other components of the powertrain. For example, the engagement elements 138 formed on the parallel region 130c may be configured to cooperate and engage with corresponding engagement features formed on the secondary components (e.g. engagement elements 211 of a gear 212 shown in FIGS. 16 and 18) disposed within the tubular member 108. The engagement elements 138, 140 may be formed by rack rolling, rotary spline rolling, single action cam forming, double action cam forming, or other forming operations as desired. In other embodiments, the engagement elements 138 and/or the engagement elements 140 may be formed during the operation used to produce the preform 102 such as by stamping, for example. As such, the tubular member 108 may be formed with the engagement elements 138 and/or the engagement elements 140 already provided in the preform 102, thus eliminating the manufacturing process needed for the engagement elements 138, 140 after forming of the tubular member 108, which process may be costly and time consuming.

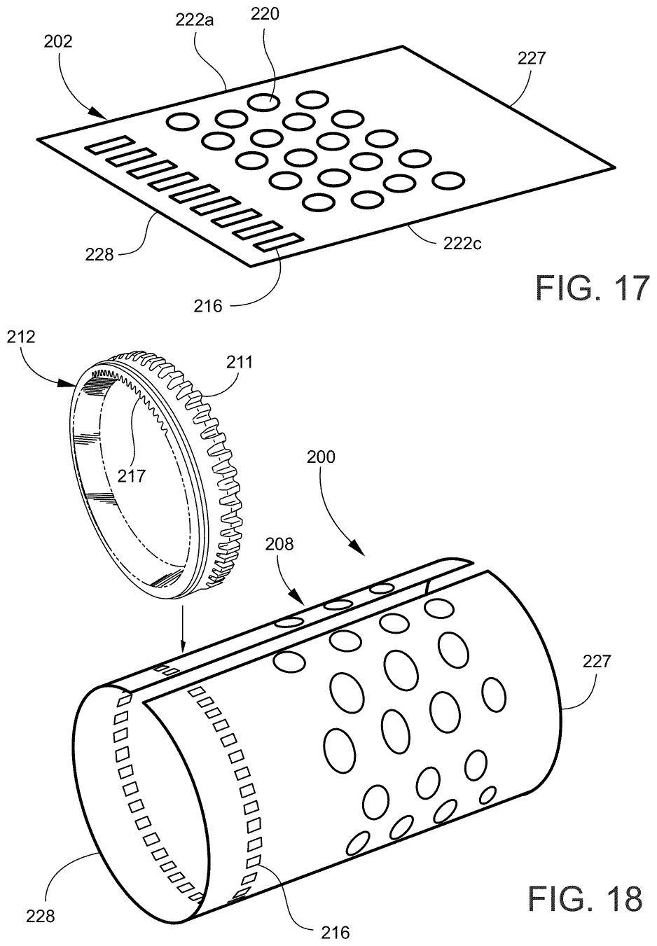

A method 2000, shown in FIG. 15, may be employed to produce a drum 200, shown in FIG. 16 in accordance with another embodiment of the presently disclosed subject matter. Similar to the method 1000 described hereinabove, the method 2000 includes step 2010 providing at least one source of at least one material (not depicted). In step 2020, a preform 202 (see FIG. 17) is formed from the at least one source of the at least one material. Thereafter, in step 2024, the preform 202 is manipulated (see FIG. 18) and edges 222a, 222b thereof are rolled to form a rolled preform 202. In step 2028, one or more of secondary components 212 such as a gear, for example, may be disposed and/or assembled within the rolled preform 202. Subsequently, in step 2030, the edges 222a, 222b are joined to form a tubular member 208 (see FIG. 16). The method 2000 may further comprise step 2040 in which an expansion operation and/or a contraction operation is performed on the tubular member 208. The tubular member 208 may then be subjected to a heat-treating process for formability in step 2050. A plurality of engagement elements (e.g. splines) (not depicted) may then be formed on an inner surface of the tubular member 208 and/or a plurality of engagement elements (e.g. splines) (not depicted) formed on an outer surface of the tubular member 208 in step 2060, if desired. In step 2070, limited machining may also conducted on the tubular member 208. Heat-treating may again be performed at step 2080 to achieve a desired hardness of the tubular member 208. In step 2090, other secondary components 212 may be disposed and/or assembled with the tubular member 208 to produce the drum 200. Thereafter, the drum 200 may be balanced in step 2100.

The inventive manufacturing method 2000 and design of the drum 200 are considerably different from the current process and design of conventional drums. However, the drum 200 is configured to be used into existing packaging constraints.

To produce the generally planar preform 202, it is separated from the at least one source of the at least one material. Such process may involve “unfolding” the material from the one or more sources. The preform 202 may be formed by stamping, cutting, snipping, a combination of various forming processes, and the like, for example. Preferably, the preform 202 includes as many features of the drum 200 as possible in the preform 202. The features of the drum 200 which may be provided in the preform 202 include, but are not limited to, a developed profile of the preform 202 that, when rolled, forms a desired shape (i.e. a substantially right cylindrical tube shape, a substantially conical tube shape, and the like); at least one aperture 220; the edges 222a, 222b formed in a condition for joining with each other; a generally interference-free element (not depicted) suitable for sensor readability; receiving elements 216 for cooperation with one of the secondary components 212; and/or the engagement elements configured to cooperate and engage with one or more of the secondary components 212 and/or other components of the powertrain. It should be appreciated that the preform 202 may be provided with more or less features than shown to reduce or eliminate manufacturing and/or assembling processes needed to produce the drum 200.

As illustrated in FIGS. 16-18, the preform 202 may be formed with a plurality of the apertures 220. The apertures 220 may formed through the preform 220 in any suitable pattern, configuration, number, shape, and size as desired to reduce a weight of the drum 200, balance the drum 200, and/or permit a flow of a fluid (i.e. oil) therethrough. The preform 202 may also include an array of the receiving elements 216 formed therethrough. It is understood that the preform 202 may include any number, shape, size, and configuration of receiving elements 216 as desired. Each of the receiving elements 216 may be configured to cooperate and receive a corresponding one of a plurality of protuberances 211 formed on the one of the secondary components 212 disposed within the drum 200. In the embodiment shown, each of the receiving elements 216 is a generally rectangular slot configured to receive a corresponding tooth formed on an outer circumferential surface of a gear disposed within the drum 200. As more clearly seen in FIGS. 16 and 18, the secondary component 212 may further include a plurality of engagement elements 217 (e.g. teeth) formed on an inner surface thereof. The engagement elements 217 may be configured to cooperate and engage with a plurality of engagement elements formed on one or more of the secondary components 212 and/or other components of the powertrain.

In one embodiment, the preform 202 may be formed as a one-piece preform 202 as shown in FIG. 17. In other embodiments, however, the preform 202 may be a multi-piece preform 202 comprising a plurality of pieces joined together by any joining method. For example, the pieces of the preform 202 may be joined together by a welding operation. A thickness of the preform 202 may be substantially equal to a thickness of a finished wall thickness of the drum 200 which eliminates a need for machining stock. It is understood that the thickness of the preform 202 may be generally constant. However, the thickness of the preform 202 may be varied. In certain embodiments, at least two of the pieces of the multi-piece preform 202 may have different thickness, thereby resulting in a varied, finished wall thickness of the drum 200, if desired. By varying the wall thickness of the drum 200, a product weight and cost may be reduced. One material used to produce the preform 202 may be an aluminum material. However, it is understood that other materials having required properties may be used as desired such as a steel material, for example. It should be appreciated that the preform 202 may be formed completely from one material or numerous materials, if desired. For the multi-piece preform 202, at least two of the pieces may be formed from different materials.

The tubular member 208 may further include the element suitable for sensor readability. In some embodiments, the element may be part of a sensor (not depicted). It is understood that the element may be integrated into the tubular member 208. More preferably, the element may be integrally formed into the preform 202 prior to rolling and forming thereof. This would eliminate the assembly and stake operations and management of another component supplier currently required in conventional drums, while reducing capital equipment spend and improving product quality of the inventive drum 200. An aluminum material may be employed for the element to allow the sensor to monitor parts inside of the drum 200. It is understood, however, that the material used for the element may be any material suitable for sensor readability and/or to allow monitoring of the parts inside the drum 200 as desired. In the embodiments employing the multi-piece preform 202, at least a portion of one of the pieces joined together to form the preform 202 may form the element, reducing a cost of the drum 200 without changing a function thereof. As a non-limiting example, the at least a portion of the one of the pieces may be formed from the aluminum material. As another non-limiting example, one of the pieces of the preform 202 may be produced from a steel material having an aluminum strip for the element integrated therein. As a further embodiment, a bi-metallic preform 202 may be employed. The bi-metallic preform 202 may be produced from a combination of steel and aluminum materials. It should be appreciated that the piece or the portion of the preform 202 produced from the aluminum material may be relatively small.

Once the preform 202 is formed, the preform 202 may be manipulated to form a rolled preform 202 as shown in FIG. 18. In the embodiment shown, the preform 202 is roll formed or press formed into either the substantially right cylindrical tube shape or the substantially conical tube shape. The one or more secondary components 212 are then disposed within the rolled preform 202. In certain embodiments, one of the secondary components 212 is gear disposed in the rolled preform 202 in such a manner that each of the radially outwardly extending protuberances 211 of the secondary component 212 is inserted into a corresponding one of the receiving elements 216 formed in the preform 202. The edges 222a, 222b of the rolled preform 202 are joined together to form the tubular member 208 and secure the one or more secondary components 212 therein. In one embodiment, the edges 222a, 222b of the rolled preform 202 may be seam welded to form the tubular member 208. However, it is understood that any rolling process or joining process can be used. In some embodiments, the edges 222a, 222b may be joined using laser welding to form a seam 226. Once joined, the seam 226 between the edges 222a, 222b of the preform 202 may be planished to improve a formability of the tubular member 208. Other metalworking techniques may also be used if desired.

Subsequent to the joining step and the planishing step, the tubular member 208 may undergo at least one of an expansion operation and a contraction operation to further form the tubular element 208 illustrated in FIG. 16. The purpose of the expansion operation and/or the contraction operation may be to improve diametral tolerances of the rolled and welded tubular member 208 and/or setting spline diameters parallel to a central A-axis if the tubular member 208 has a generally conical shape. When the tubular member 208 has the generally conical shape, an inner diameter gradually decreases from a first end 227 to a second end 228 thereof.

In certain embodiments, the tubular member 208 may comprise at least one parallel region and/or at least one conical region relative to the central A-axis substantially similar to the regions 130, 132 formed in the drum 100 shown in FIGS. 10 and 11. Formation of the parallel regions and/or the conical regions may be conducted in any order. For example, the parallel regions may be formed prior to formation of the conical regions and vice versa. In another embodiment, the parallel regions and the conical regions are formed in an alternating manner with one another. In yet other embodiments, the parallel regions and the conical regions are formed concurrently.

In accordance with one embodiment, the tubular member 208 may comprise a plurality of parallel regions relative to the central A-axis. Each of the parallel regions may be separated from another one of the parallel regions by a perpendicular step. Each diameter of the respective parallel regions is generally constant along a length thereof yet gradually decrease along a length of the tubular member 208 from one of the diameters to an adjacent one of the diameters to form a generally conical shape.

In yet another embodiment shown in FIG. 16, the tubular member 208 may have a generally constant diameter along the length thereof to form a substantially right cylindrical shape. As such, the diameter of each of the parallel regions may be the same or substantially similar.

A first plurality of the engagement elements (not depicted) may be formed on an inner surface of the tubular member 208 intermediate the first end 227 and the second end 228 thereof after the expansion operation and/or the contraction operation. In a non-limiting example, each of the parallel regions may include the engagement elements formed on an inner surface thereof. Further, an outer surface of the tubular member 208 may include a second plurality of the engagement elements (not depicted) formed thereon intermediate the first end 227 and the second end 228 thereof. In certain embodiments, the first plurality of engagement elements may be configured to cooperate and engage with one or more secondary components 212 disposed within the tubular member 208 and/or the second plurality of engagement elements may be configured to cooperate and engage with other components of the powertrain. The engagement elements may be formed by rack rolling, rotary spline rolling, single action cam forming, double action cam forming, or other forming operations as desired. In other embodiments, the first plurality of the engagement elements and/or the second plurality of engagement elements may be formed during the operation used to produce the preform 202 such as by stamping, for example. As such, the tubular member 208 may be formed with the first plurality of the engagement elements and/or the second plurality of the engagement elements already provided in the preform 202, thus elimination the manufacturing process needed for the engagement elements after forming of the tubular member 208, which process may be costly and time consuming.

There are numerous advantages of forming the drums 100, 200 according to the methods 1000, 2000 disclosed herein. First, the amount of the material used and the machining required for the drums 100, 200 are both reduced over the methods employed to produce the drums of the prior art. The methods 1000, 2000 also utilize the source of material in an as-supplied condition. Unlike the methods of the prior art, which require full machining on an outer surface of the conventional drums to achieve a desired outer diameter, a further advantage of the methods 1000, 2000 is incorporation of final part features in the stamped preform 102, 202 requiring less materials, labor, capital equipment, floor space, and the like etc. The stamping process to provide the preforms 102, 202 of the drums 100, 200 is relatively inexpensive. Compared to the conventional methods of producing the drums, which comprise a notching process that is slow and requires expensive equipment, the apertures 120, 220 formed in the drums 100, 200, respectively, for weight reduction, oil circulation, and/or balance purposes can be formed in the same press hit that forms the preforms 102, 202, thereby eliminating later processes which would be required to form these features. Another advantage of the methods 1000, 2000 is process flexibility. The inventive methods 1000, 2000 may be performed using equipment that is inherently flexible with regard to the drums 100, 200 that can be manufactured. This allows for greater flexibility for a product engineer and relatively straightforward application of the methods 1000, 2000 and drums 100, 200 for other applications. Yet another advantage is the cost savings. The efficiencies of the methods 1000, 2000 provide for major cost savings over the existing conventional methods. For example, forming the drum 200 using the alternative method 2000 is less costly by employing the receiving elements 216 instead of splines formed in the drum 100, which also eliminates a snap ring required to retain the secondary component 212.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of producing a drum, comprising:
providing at least one source of at least one material;
producing a preform from the at least one material having at least one feature of the drum formed therein;
forming the preform into a tubular member; and
assembling at least one secondary component with the tubular member to produce the drum.

2. The method of claim 1, wherein the forming of the preform into the tubular member includes bending edges of the preform into a rolled tube shape and joining the edges to form the tubular member.

3. The method of claim 1, further comprising performing at least one of an expansion operation and a contraction operation to form at least one region in the tubular member having at least one desired diameter of the drum.

4. The method of claim 3, wherein the performing of the at least one of the expansion operation and the contraction operation forms in the tubular member a first parallel region, a second parallel region, a third parallel region, a first conical region formed between the first and second parallel regions, and a second conical region formed between the second and third parallel regions.

5. The method of claim 3, wherein the performing of the at least one of the expansion operation and the contraction operation forms in the tubular member a plurality of parallel regions, and wherein each of the parallel regions is separated from another one of the parallel regions by a perpendicular step.

6. The method of claim 1, further comprising heat-treating the tubular member for formability of the tubular member.

7. The method of claim 5, wherein the heat-treating of the tubular member for formability is after performing at least one of an expansion operation and a contraction operation on the tubular member.

8. The method of claim 1, further comprising forming at least one engagement element in the tubular member.

9. The method of claim 1, further comprising machining the tubular member.

10. The method of claim 1, further comprising heat-treating the tubular member to achieve a desired hardness.

11. The method of claim 1, further comprising balancing the drum.

12. The method of claim 1, wherein the at least one feature of the drum includes at least one aperture.

13. The method of claim 1, wherein the at least one feature of the drum includes at least one engagement element configured to cooperate and engage with at least one of the at least one secondary component and at least one component of a powertrain of a vehicle.

14. The method of claim 1, wherein the at least one feature of the drum includes at least one receiving element configured to cooperate with the at least one secondary component.

15. The method of claim 1, wherein the at least one feature of the drum includes an element suitable for sensor readability.

16. The method of claim 15, wherein at least a portion of the element suitable for sensor readability is produced from an aluminum material.

17. The method of claim 1, wherein the at least one secondary component is a gear of a powertrain of a vehicle.

18. The method of claim 1, wherein the forming of the preform produces one of a substantially right cylindrical tubular member and a substantially conical tubular member.

19. A method of producing a drum, comprising:
providing at least one source of at least one material;
producing a preform from the at least one material, the preform having at least one feature of the drum formed therein, wherein the at least one feature of the drum includes an array of receiving elements formed therein;
forming the preform into a rolled preform;
disposing a gear into the rolled preform, the gear having a plurality of protuberances formed on an outer circumferential surface thereof, wherein each of the protuberances of the gear is received in a corresponding one of the receiving elements formed in the rolled preform; and
joining edges of the rolled preform to form a tubular member and secure the gear therein.

20. A powertrain drum for a vehicle, comprising:
a tubular member produced from a preform having at least one feature of the powertrain drum provided therein, wherein the tubular member includes at least one of a plurality of engagement elements and a plurality of receiving elements formed therein; and
at least one secondary component disposed in the tubular member, wherein the at least one secondary component cooperates with at least one of the engagement elements and the receiving elements of the tubular member to maintain a position thereof within the tubular member.
